(19) United States
(12) Patent Application Publication
(10) Pub. No.: US 2008/0033594 A1
(43) Pub. Date: Feb. 7, 2008

(54) METHOD OF OUTPUTTING OFFERS AT A VENDING MACHINE

(76) Inventors: John M. Packes JR., Hawthorne, NY (US); Daniel E. Tedesco, Westport, CT (US); Magdalena M. Fincham, Norwalk, CT (US)

Correspondence Address: WALKER DIGITAL MANAGEMENT, LLC, 2 HIGH RIDGE PARK, STAMFORD, CT, 06905, US

(21) Appl. No.: 11/873,127

(22) Filed: Oct. 16, 2007

Related U.S. Application Data
(62) Division of application No. 09/714,574, filed on Nov. 16, 2000.

(51) Int. Cl. G06F 17/00

(52) U.S. Cl. 700/232

(57) ABSTRACT

A network of vending machines is interfaced via a controller to a network of devices installed at retail establishments. When a customer goes to a vending machine and requests a transaction such as dispensing a product from the vending machine, the vending machines outputs an offer to the customer in response to the received request and based on a condition that has been identified at one of the retail establishments. The identified condition may be a lack of customer traffic at the retail establishment. The offer outputted at the vending machine may be a discount coupon to induce the customer to visit the retail establishment. Preferably, the retail establishment is nearby to the vending machine which outputted the offer. The vending machine may also output offers when the vending machine is out of stock of the item requested by the customer.

### CROSS-REFERENCE TO RELATED APPLICATIONS

The present application is a divisional application that claims priority and benefit under 35 U.S.C. §121 to U.S. patent application Ser. No. 09/714,574 entitled “METHOD OF OUTPUTTING OFFERS AT A VENDING MACHINE FIELD”, filed Nov. 16, 2000.

Each of the above-referenced applications is hereby incorporated by reference herein.

The present application is also related to the following U.S. Patent Applications:
(i) U.S. patent application Ser. No. ______ (Docket No. 00-068-2), entitled “METHOD OF OUTPUTTING OFFERS AT A VENDING MACHINE FIELD”, filed Oct. 16, 2007 in the name of Packes et al., and
(ii) U.S. patent application Ser. No. ______ (Docket No. 00-068-3), entitled “METHOD OF OUTPUTTING OFFERS AT A VENDING MACHINE FIELD” filed Oct. 16, 2007 in the name of Packes et al.

### FIELD

The present invention is concerned with vending machines, and, more particularly, is concerned with using vending machines to output promotional offers to customers.

### BACKGROUND

U.S. Pat. No. 4,717,043 to Groover et al. discloses a vending machine that dispenses coupons.

U.S. Pat. No. 5,557,721 to Fite et al. discloses a beverage container redemption machine that prints coupons based on information downloaded from a host system. The coupon printing may be limited to a predetermined time period.

U.S. Pat. No. 5,769,269 to Peters discloses a network of vending machines having printing capabilities and connected via telephone lines to a host location.

U.S. Pat. No. 5,959,869 to Miller et al. discloses a vending machine that can be remotely programmed for promotional campaigns such as a “buy one get one free” promotion.

U.S. Pat. No. 5,620,079 to Molbak discloses a coin counter/sorter that also dispenses coupons. The coupons can be altered depending on factors such as time of day.

An article by Ephraim Schwartz entitled “Controlling the Clients” published on Aug. 28, 2000 in InfoWorld describes a gasoline pump that prints out a coupon that is redeemable at a nearby store.

An Israeli company called TeleVend has proposed a vending machine that dispenses a discount coupon redeemable at a local restaurant.

The prior art has not recognized that it would be desirable to selectively use vending machines to output offers to direct customer traffic to nearby retail stores depending on changing circumstances.

### SUMMARY OF THE INVENTION

According to an aspect of the invention, a method of operating a vending machine includes receiving a request for a transaction from a customer at the vending machine, identifying a condition at a retail establishment, and, based on the identified condition, outputting an offer to the customer in response to the received request. The outputted offer may be a coupon to be redeemed at the retail establishment, and the condition identified at the retail establishment may be the frequency of sales transactions at the retail establishment. The method according to this aspect of the invention may further include transmitting a signal from the retail establishment to indicate the identified condition. The identified condition may be a state of a service queue at the retail establishment or the condition may relate to a state of inventory at the retail establishment. In the latter case, the condition may relate to whether a particular product is in stock at the retail establishment. The method according to this aspect of the invention may further include storing at the vending machine data representative of the offer.

According to another aspect of the invention, a method of operating a vending machine includes receiving a request for a transaction from a customer at the vending machine, determining whether the requested transaction can be performed by the vending machine, and, if it is determined that the requested transaction cannot be performed at the vending machine, outputting an offer to the customer in response to the received request. The outputted offer may be a coupon to be redeemed at a retail establishment. The method according to this aspect of the invention may be arranged so that the offer is outputted only when a predetermined condition is identified at a retail establishment.

The method according to this aspect of the invention may be arranged such that the determining step includes determining whether the vending machine is out of stock of an item requested in the request for a transaction.

According to still another aspect of the invention, a method of operating a vending machine includes determining a condition at a retail establishment; in response to the determined condition, transmitting a trigger signal to a vending machine; and, in response to the trigger signal, outputting an offer to a customer at the vending machine. The offer may be outputted upon the customer requesting a transaction at the vending machine.

From the point of view of the retail store, the present invention is advantageous in that it tends to provide increased customer traffic, particularly at times when business is slow, thereby leading to improved financial results for the retail store.

The invention may also be advantageous from the point of view of proprietors of vending machines, since the retailers or other parties may be willing to compensate the vending machine proprietors for the promotional services performed by vending machines in outputting offers. Furthermore, to the extent that offers are outputted by vending machines when the customer has requested an out of stock item, the offer may help to soothe adverse feelings or disappointment on the part of the customer due to the vending machine being out of stock. Moreover, the system of the present invention helps to tie vending machines in to the communities in which they are installed.

Customers may also find the system of the present invention to be advantageous in that the offers extended to customers may allow them to obtain favorable treatment at retailers to which the customer is directed. This favorable treatment may be particularly welcome when the customer has found the vending machine to be out of stock for the customer's desired purchase.

### BRIEF DESCRIPTION OF THE DRAWINGS

FIG. 1A is a block diagram of a system provided in accordance with an embodiment of the invention.

FIG. 1B is a block diagram of a system provided according to another embodiment of the invention;

FIG. 2 is a block diagram of a controller that is part of the system of FIG. 1A;

FIG. 3 is a block diagram of a typical vending machine included in the systems of FIG. 1A or 1B;

FIG. 4 is a tabular representation of a retailer database shown in FIG. 2;

FIG. 5 is a tabular representation of a vending machine database shown in FIG. 2;

FIG. 6 is a tabular representation of an associations database shown in FIG. 2;

FIG. 7 is a tabular representation of an offer database shown in FIG. 2;

FIG. 8 is a tabular representation of an inventory database shown in FIG. 3;

FIG. 9 is a tabular representation of an offer output database shown in FIG. 3;

FIG. 10 is a tabular representation of a qualifying condition database shown in FIG. 2;

FIG. 11 is a flow chart that provides an overview of a process carried out by a system provided in accordance with the invention;

FIG. 12 shows an example of a coupon that is outputted by a vending machine in accordance with the invention;

FIG. 13 is a flow chart that illustrates a process carried out by a vending machine in accordance with the invention;

FIG. 14 is a flow chart that illustrates a process carried out by a retailer device in accordance with the invention;

FIG. 15 is a flow chart that illustrates a process carried out by the controller of FIG. 2 in accordance with the invention;

FIG. 16 is a flow chart that illustrates a process carried out by a vending machine in accordance with the invention;

FIG. 17 is a flow chart that illustrates a process carried out by a vending machine in accordance with the invention; and

FIG. 18 is a flow chart that illustrates a process carried out by the controller of FIG. 2 in accordance with the invention.

### DETAILED DESCRIPTION

The following definitions shall apply in this specification and in the appended
offer: includes a coupon or any other proposal outputted by a vending machine to induce a customer to patronize a retail establishment.
retail establishment: a convenience store, fast food restaurant, supermarket, drug store, department store, discount department store or any other retail store.
service queue: a line of customers awaiting service at a retail establishment.
vending machine: any automatic sales machine that allows payment to be exchanged for goods or services, including snack machines, beverage machines, automatic teller machines (ATMs), postage stamp dispensers, parking meters, electronic highway toll booths that deduct a toll charge from a motorist's pre-paid account or credit card, arcade games, slot machines and laundry machines.

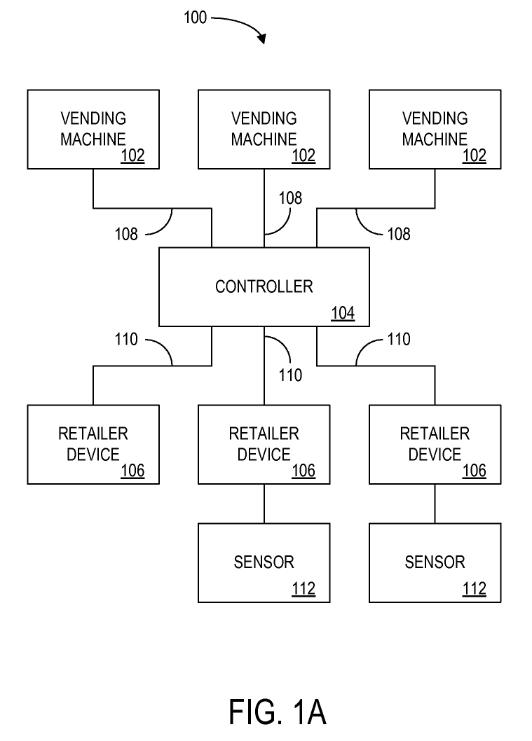

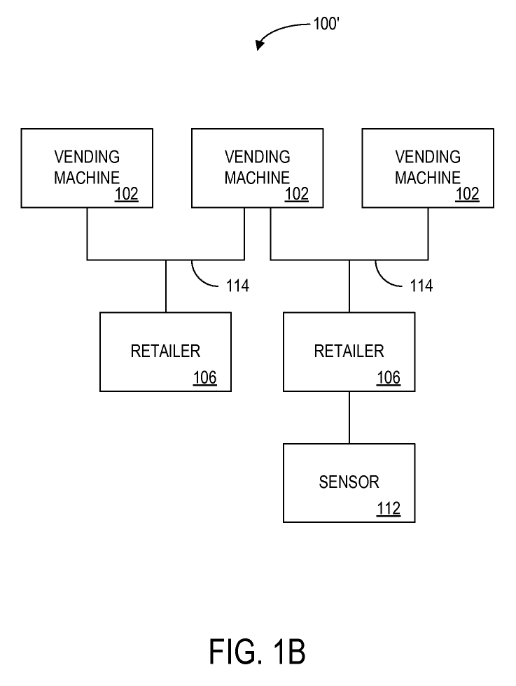

FIG. 1A is a block diagram representation of a system 100 provided in accordance with the invention. The system 100 includes vending machines 102, a controller 104 and retailer devices 106. Communication links 108 permit vending machines 102 to exchange data communications with the controller 104. Communication links 110 permit retailer devices 106 to exchange data communications with controller 104. The communication links 108, 110 may be constituted by one or more of the Internet, a local area network (LAN), a wide area network (WAN), a telephone line, a telecommunications cable, a radio channel, an optical communications link, an infrared communications channel and a satellite communications link. One or more of the following communications protocols may be employed: TCP/IP, Ethernet and Bluetooth™. Although communication links 108, 110 are shown as being separate from each other, all may be constituted by a single network such as the Internet.

The retailer devices 106 are preferably installed in retail establishments. Each retailer device 106 may be a personal computer, a point-of-sale terminal or other device capable of storing information and exchanging data with the controller 104. At least some of the retailer devices 106 may have connected thereto one or more sensors 112 for detecting conditions at the retail establishments at which the retailer devices are located. For example, sensors 112 may include motion sensors or infrared sensors to detect the presence of customers at the retail store or entry of customers into the retail establishment. A sensor 112 may also take the form of a digital image analyzing device which is able to analyze surveillance video images to detect entry of or presence of individuals. The sensor devices 112 may also include point-of-sale terminals that track rates at which transactions are taking place. Where the retailer device 106 is a point-of-sale terminal, the retailer device 106 may itself detect a condition such as the rate at which transactions are taking place at the retail establishment.

The vending machines may be located some distance from, or immediately outside, retail establishments with which they are associated.

FIG. 1B is a block diagram that illustrates a system 100′ provided according to an alternative embodiment of the invention. In the system 100′ no controller is present. Instead, retailer devices 106 communicate directly with one or more vending machines 102 via communication links 114. The communication links 114 may be constituted in the same manner as the communication links 108, 110 discussed in connection with FIG. 1A.

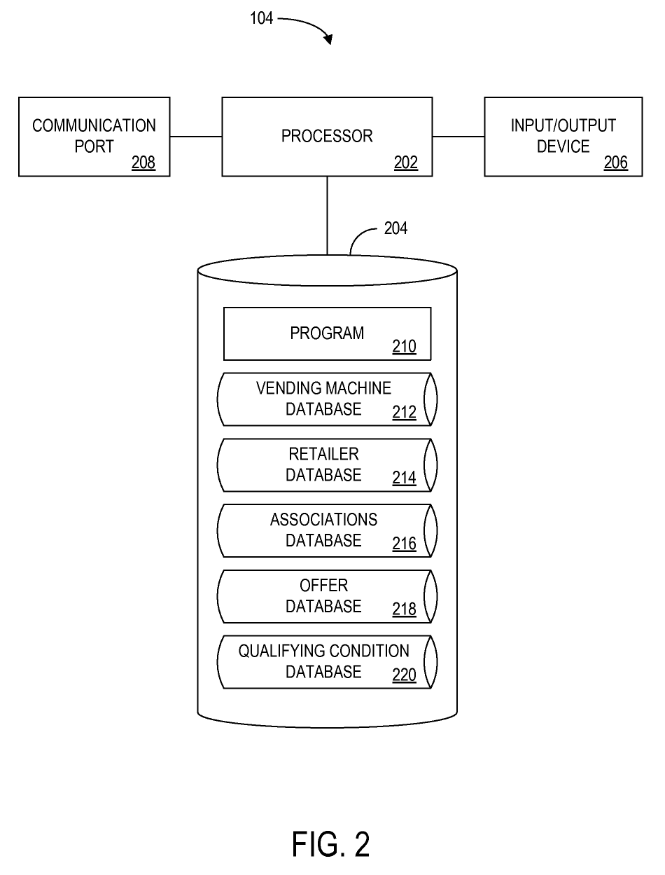

FIG. 2 is a block diagram showing the architecture of an illustrative controller 104. The controller 104 may be embodied, for example, as an RS6000 server manufactured by IBM Corporation, as modified herein to execute the functions and operations of the present invention. The controller 104 includes known hardware components such as a central processing unit 202 in communication with each of a data storage device 204, input/output devices 206 and a communications port 208. The data storage device 204 preferably comprises an appropriate combination of magnetic, optical and/or semiconductor memory and may be constituted by one or more hard disks. The processor 202 may be embodied as a single processor or a number of processors. The processor 202 and the storage device 204 may each be, for example: (i) located entirely within a single computer or other computing device; or (ii) connected to each other by a remote communication medium, such as a serial port cable, telephone line or radio frequency transceiver.

The data storage device 204 stores a program 210 that controls the processor 202 in accordance with the invention. Also stored in the data storage device 204 are a vending machine database 212, a retailer database 214, an associations database 216, an offer database 218 and a qualifying condition database 220. The vending machine database 212 stores information relating to the vending machines 102 that are included in the system 100. The retailer database 214 stores information concerning retail establishments at which the retailer devices 106 are installed. The associations database 216 stores information to indicate which ones of the vending machines 102 are associated with each one of the retail establishments at which the retailer devices 106 are installed. The offer database 218 stores information relating to offers to be outputted by the vending machines 102.

Qualifying condition database 220 stores information indicative of conditions that determine on what occasions the offers are to be outputted by the vending machines 102. Instead of or in addition to storing the qualifying database in the controller 204, this database may be stored in one or more of the vending machines 102 and/or in one or more of the retailer devices 106.

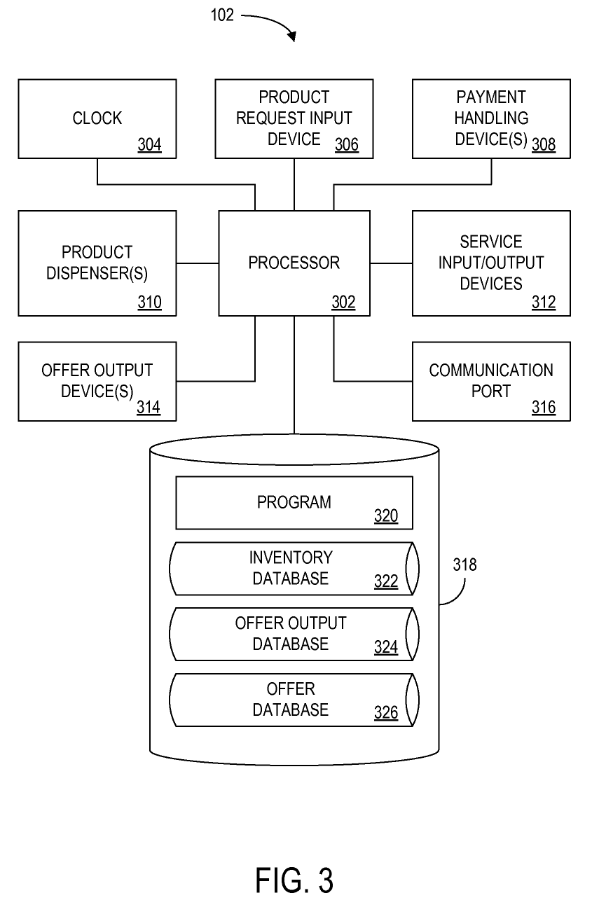

FIG. 3 is a schematic block diagram that illustrates one exemplary vending machine 102 suitable for use in the system of the present invention. The present invention may be applied with any automatic sales machines that allows payment to be exchanged for goods or services. Payment can be presented through a variety of media including, but not limited to, coins, bills and other currencies, magnetic stripe cards such as credit cards, smart cards (whether pre-paid or linked to an account), and identification codes. It is also contemplated that payment for vended items may be made on-line either before or after receiving the vended item. Payment can also be handled through a charge to a cellular telephone account or other account based on interaction between the vending machine 102 and a cellular telephone carried by a customer who wishes to purchase an item from the vending machine.

Vending machine 102 is controlled by a processor 302 which may include any commonly manufactured microprocessor chip, such as the Pentium II manufactured by Intel Corporation. The processor 302 runs at a clock speed determined by clock 304 which is operatively connected to processor 302.

Also connected to processor 302 are one or more product request input devices 306 which permit the customer to indicate selection of a product to be dispensed. For example, the product request input devices 306 may include an array of push buttons. Actuation of a selected one of the push buttons functions as a request to dispense a product that corresponds to the selected push button.

Also connected to processor 302 are one or more payment handling devices 308, such as a coin acceptor and a bill validator. The payment handling devices 308 may also include (a) a card reader for reading a magnetic stripe card and/or a smart card, or (b) a device that permits the vending machine 102 to be dialed up by a cellular phone so that the product purchase may be charged to the customer's cellular phone account.

The vending machine 102 also includes one or more product dispensers 310. The product dispensers 310 dispense products requested through the product request input device 306 and paid for through a payment handling device 308.

Also operatively connected to the processor 302 are service input/output devices 312 which are only accessible when the vending machine 102 has been opened up for servicing by a service employee. The service input/output devices 312 permit the service employee to interact with the vending machine by means of, for example, a hand-held device (not shown) so that the servicer may access and update data stored by the vending 102. It is contemplated that the service input/output devices 312 may be used to load into the vending machine 102 data indicative of one or more offers to be outputted by the vending machine. The service input/output devices 312 may also be used to download from the vending machine information regarding offers that have been outputted by the vending machine.

The processor 302 is also operatively connected to one or more offer output devices 314. The offer output devices 314 may include a coupon printer for printing and dispensing offer coupons to be provided to the customer under certain circumstances. In addition or alternatively, the offer output devices 314 may include a display such as a CRT or an LCD text display to display the text of an offer. As other alternatives, the output offer devices 314 may include a speaker to produce an audio message to the customer, or a radio frequency or infrared transceiver to transmit offer information to a device held by the customer such as a personal digital assistant (PDA). The offer output device 314 may also transmit offer information to a cell phone held by the customer.

Processor 302 is also in communication with a communications port 316. The communications port 316 permits the processor 302, and hence the vending machine 102, to engage in data communications with controller 104. As an alternative to loading offer information into the vending machine 102 via the service input/output devices 312, such information may be downloaded to the vending machine 102 from the controller 104 via the communications port 316.

The processor 302 is also in communication with a data storage device 318. The data storage device 318 comprises an appropriate combination of magnetic, optical and/or semiconductor memory, and may include, for example, random access memory (RAM), read only memory (ROM), a compact disc and/or a hard disk. The data storage device 318 stores a program 320 for controlling the processor 302.

The processor 302 performs instructions of the program 320, and thereby operates in accordance with the present invention, and particularly in accordance with the methods described in detail herein. The program 320 may be stored in a compressed, uncompiled and/or encrypted format. The program 320 further includes program elements that may be necessary, such as an operating system, a database management system and “device drivers” for allowing the processor 302 to interface with peripheral devices included in the vending machine 102. Appropriate program elements are known to those skilled in the art, and need not be described in detail herein.

According to an embodiment of the present invention, the instructions of the program 320 may be read into a main memory from another computer-readable medium, such as from a ROM to RAM. Execution of sequences of the instructions in program 320 causes processor 302 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The storage device 318 also stores an inventory database 322 for keeping track of the inventory of products present in the vending machine, an offer output database 324 for maintaining a record of offers outputted by the vending machine 102, and an offer database 326. Offer database 326 may be the same as or a sub-set of the offer database 218 referred to in connection with FIG. 2.

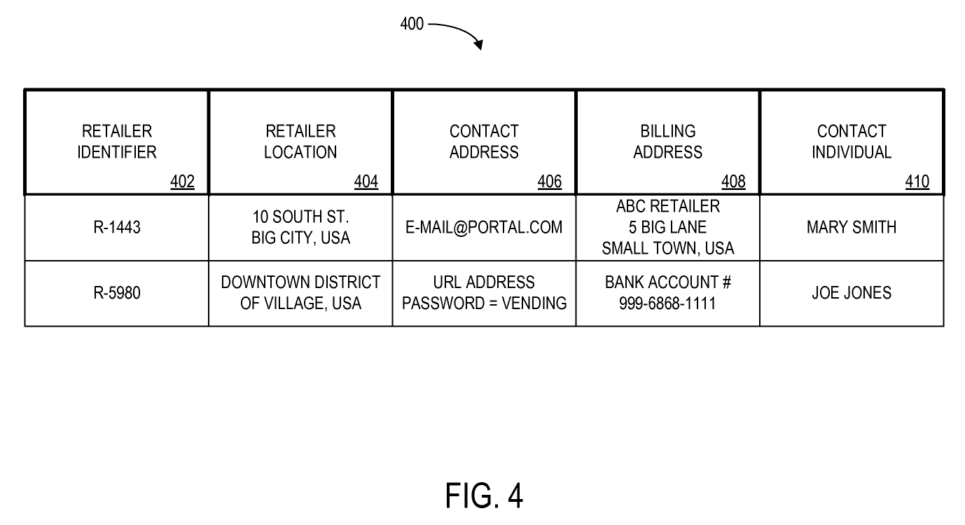

FIG. 4 shows a table 400 that represents the retailer database maintained at the controller 104. Table 400 includes a column 402 for storing retailer identifiers. Each identifier corresponds to a retailer that is participating in the system and may be a unique alphanumeric code. The retailer identifier may, for example, be assigned by the controller.

Table 400 also includes a column 404 for storing location information relative to the retail establishment that corresponds to the retailer identifier in column 402. Also included in table 400 is a column 406 for storing contact address information at which correspondence may be sent to the retailer. The contact address may be the same as the retailer location, or may be an e-mail address or a mailing address for the parent company of the retail establishment.

Column 408 of table 400 stores billing addresses for the retail establishments. This address may take the form of a mailing address to which bills are to be sent, or may be, for example, a financial account identifier that identifies a financial account to be charged with fees due from the retail establishment. The same financial account identifier may be used to credit to a retailer sums that may be due to the retailer in connection with operation of the system. At column 410 there are stored names of individual contacts at the retail establishments.

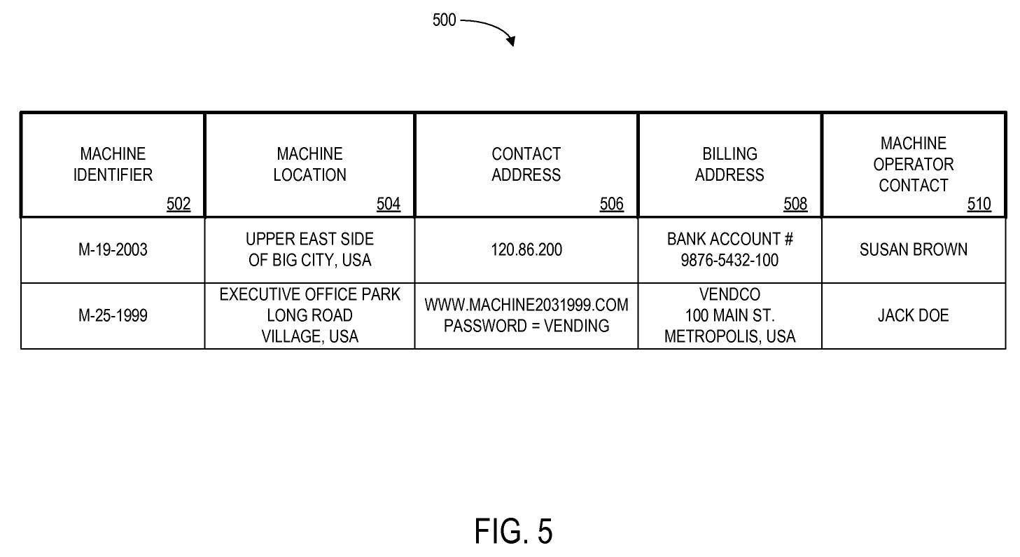

FIG. 5 shows a table 500 that represents the vending machine database 212 maintained at the controller 104.

Table 500 includes a column 502 for storing vending machine identifiers. Each identifier corresponds to a respective vending machine 102 and may be a unique alphanumeric code associated with the respective vending machine. The vending machine identifier may, for example, be assigned by the controller.

Table 500 also includes a column 504 for storing location information relative to the vending machine. The vending machine location information in column 504 may be useful for determining which vending machines to associate with various ones of retail establishments, and hence, for determining the content of offers to be output by the vending machines. It may be desirable to associate a vending machine with a retail establishment that is geographically nearby the vending machine.

Also included in table 500 is a column 506 for storing contact addresses for the vending machines. This information may be used by the controller 104 or by a retailer device 106 to carry out functions such as triggering an offer mode of the vending machine, to update the content of offers to be outputted by the vending machine or to upload information indicating when offers are to be outputted by the vending machine.

Also included in table 500 is a column 508 for storing billing address information. The billing address information may be a mailing address or a financial account identifier to permit payments or credits to be transmitted to the proprietors of the vending machines.

Finally in table 500 there is a column 510 which stores the names of individuals to contact at the proprietors of the vending machines.

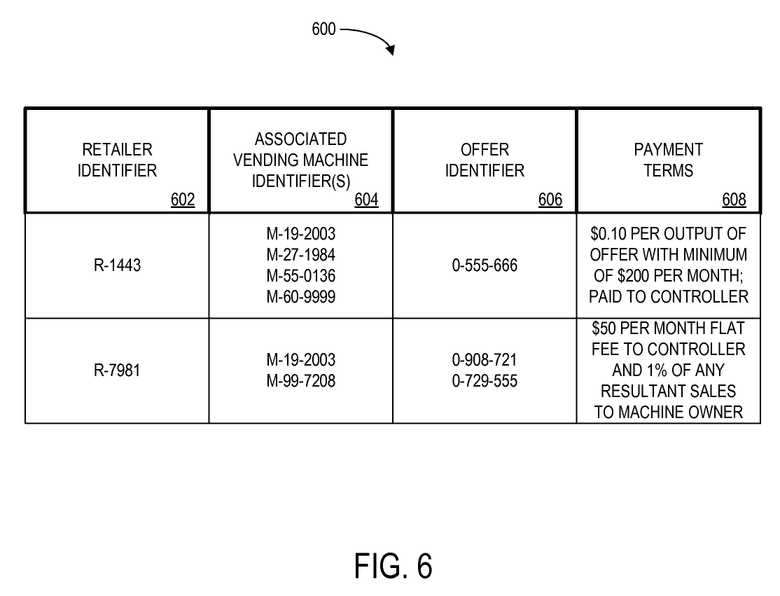

FIG. 6 shows a table 600 that represents the associations database 216 maintained at the controller 104. Table 600 includes a column 602 which lists retailer identifiers. In column 604, associated vending machine identifiers are listed, to indicate which vending machines have been associated with the retail establishment corresponding to the retailer identifier in column 602. When a vending machine has been associated with the retail establishment, this means that the vending machine may be used to output offers to direct customers of the vending machine to the associated retail establishment.

As is suggested by the example shown in table 600, more than one vending machine may be associated with a given retail establishment. Moreover, the same vending machine may be associated with more than one retail establishment.

Table 600 also includes a column 606 which lists the offer identifier corresponding to the offer to be outputted by the vending machines associated with the respective retail establishment. In the example shown in column 600, the same offer is to be outputted by all of the vending machines associated with a given retail establishment. However, it is also contemplated to have the offer to be outputted varied from machine to machine for a given retail establishment. It is also contemplated to have different offers outputted from a given machine at different times.

Table 600 also includes a column 608 which lists the terms of payment to be made by the retail establishment in regard to the offers to be outputted by the vending machines. The amount of the payment may be determined in a number of different ways, including a fixed amount per instance of outputting the offer, a fixed or minimum amount per month, or a percentage of sales resulting at the retail establishment from the outputting of the offers. The payment terms information may relate to payments to be made from the retail establishment to the proprietor of the controller (which may be the system proprietor). In addition, or alternatively, the payment terms may indicate payments to be made from the system proprietor to the proprietor of the vending machines.

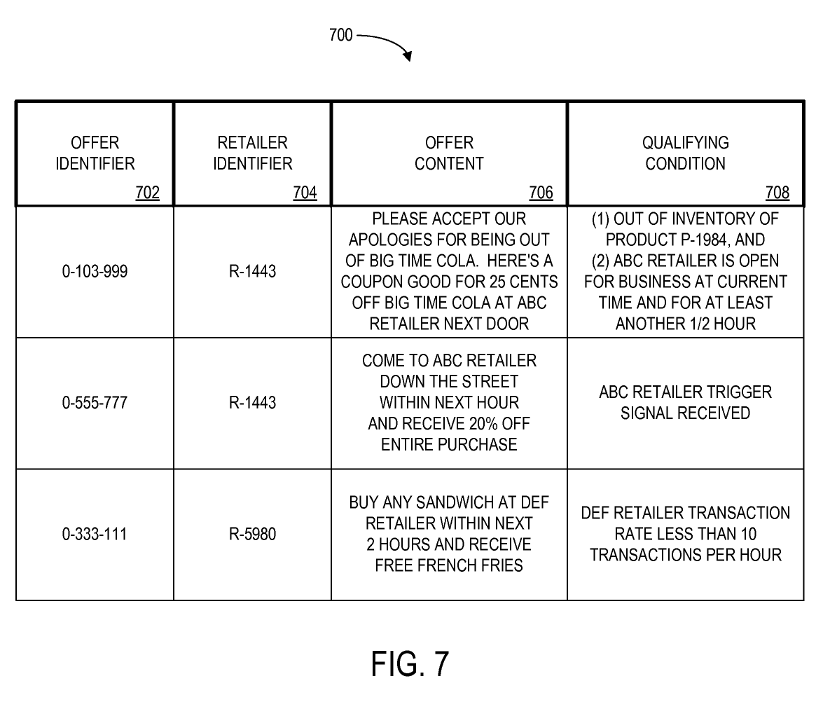

FIG. 7 shows a table 700 that represents the offer database 218 maintained at the controller 102. As noted before, some or all of this database could also be maintained at the vending machine (as offer database 326) and/or at the retailer devices 106.

Table 700 includes a column 702 for storing offer identifiers. Each offer identifier corresponds to a respective offer. Table 700 further includes a column 704 which lists retailer identifiers corresponding to the retail establishments for which the offers are to be made.

Column 706 stores the content of the offer to be outputted by the associated vending machines. For example, column 706 may include, for one offer, the text of a coupon to be printed when a vending machine is out of stock. The coupon may provide cents off for the same product if bought at a nearby retail establishment.

The text of another offer, which may be printed on a coupon, or provided as an announcement via a display and/or a speaker, may invite the customer to visit a nearby retail establishment to receive a percentage off all purchases during the next hour.

The content of still another offer, which again may take the form of a coupon or a promotional announcement at the vending machine, may entitle the customer to receive a free product when another product is purchased within a certain period of time.

Column 708 of table 700 stores conditions under which the respective offers are to be made. For one offer, the qualifying condition may be a combination of conditions, such as the vending machine being out of stock of a particular item, and the associated retail establishment being open for business. Another qualifying condition may provide for the retail establishment having transmitted a signal to trigger outputting of the offer at the corresponding vending machine. The signal may have been generated by a human operator at the retail establishment in response to the operator recognizing, e.g., that business is slow at the retail establishment. Alternatively, the signal may have been generated automatically by a retailer device at the retail establishment. The trigger signal may be transmitted to the vending machine from the retail establishment by way of the controller (in the system architecture of FIG. 1A), or may be transmitted directly from the retail establishment to the vending machine (in the system architecture of FIG. 1B). The transmission of the trigger signal may be actuated by a sensor at the retail establishment. Alternatively, the controller and/or a vending machine may query the retail establishment to determine whether a qualifying condition has been met.

Still another qualifying condition may specify that business is slow at the associated retailer, as measured in terms of number of transactions per hour.

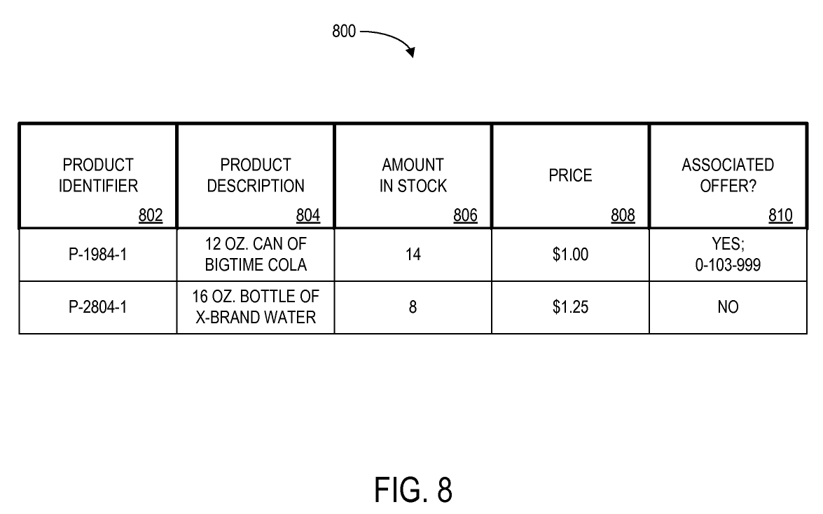

FIG. 8 shows a table 800 that represents an inventory database that may be stored in a respective vending machine 102.

In table 800, column 802 lists product identifiers that correspond to the various products dispensed by the vending machines. Column 804 lists descriptions of the products, column 806 stores data corresponding to the current quantities on hand of the products, and column 808 indicates the prices of the products. Column 810 stores an indication as to whether an offer is associated with the product (e.g. if the product goes out of stock), and if so indicates the offer identifier. As illustrated in column 810, a product may be associated with a specific offer. But even if a product is not associated with a specific offer, an offer may still be outputted when the product is out of stock. In such a case the offer selected for outputting may be selected based on other criteria, such as which retailer a trigger signal was received from.

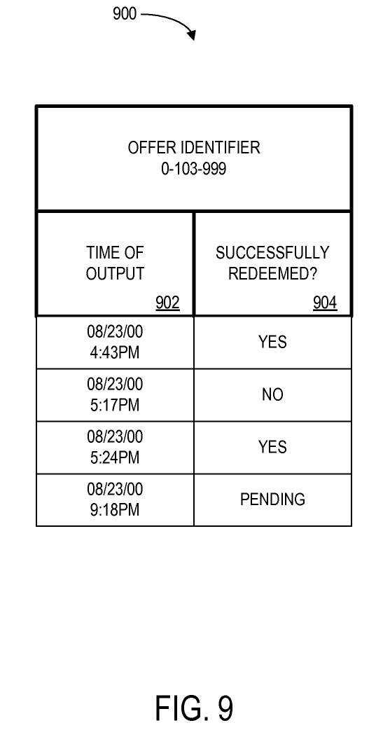

FIG. 9 shows a table 900 that represents a record from an offer output database 326 maintained in a respective vending machine 102. This information may also or alternatively be stored in the controller 104. This information is used to track payments that may be owed to a proprietor of a vending machine based on the number of times that an offer has been outputted by the vending machine. In addition or alternatively this information may be used to determine amounts due from the retail establishments based on offers made on behalf of the retail establishments.

Table 900 includes a column 902 which stores data indicative of times when the corresponding offer was outputted by the vending machine. Column 904 indicates whether the offer has been successfully redeemed. By “successfully redeemed” it is meant that the customer has redeemed the offer, which may be a coupon, within a period of time specified in the offer.

If this data is stored in the controller, the database may also include information indicative of the vending machine or vending machines at which the outputting of the offer occurred.

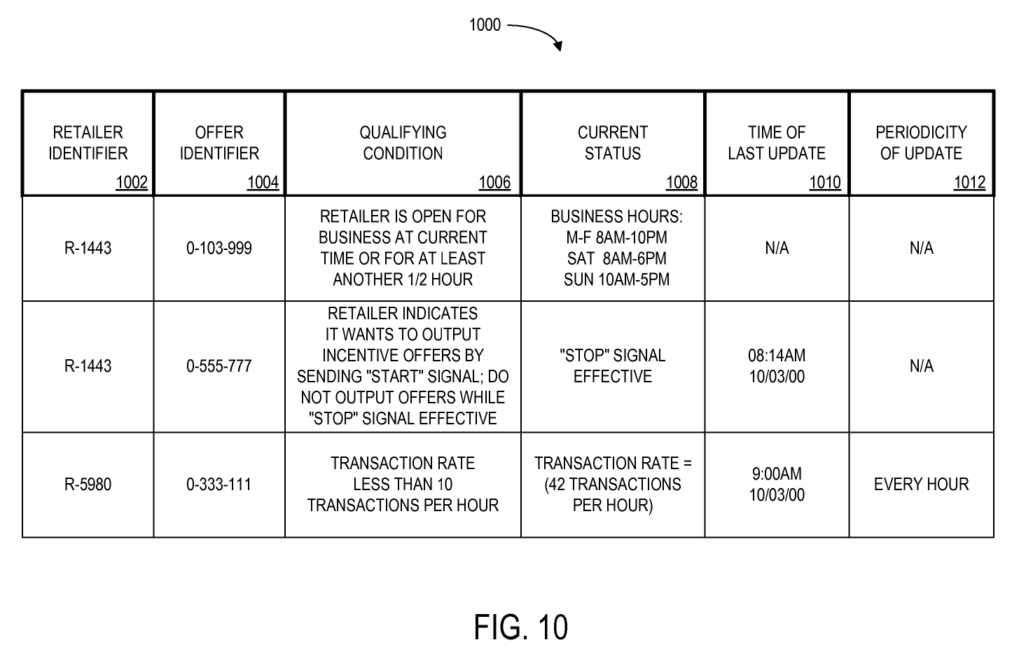

FIG. 10 shows a table 1000 that represents the qualifying condition database 220 maintained in the controller 104. This data may alternatively or additionally be stored in respective vending machines 102 and/or in retailer devices 106.

This database may be used to store and periodically update the status of a qualifying condition associated with a retail establishment. The purpose of the qualifying condition is to determine whether an offer is to be outputted from one or more associated vending machines. For the example shown in the drawing, it is assumed that the retailer device 106 initiates the update. As an alternative, the associated vending machine or the controller may initiate the update by querying the retailer device. In that case, contact information for the retailer device would preferably be stored in the database or retrieved from the retailer database when it is time to request an update. If the updates are initiated by the retailer device, the updating may be done automatically at a preset timing, or upon detection of a changed condition, or in response to manual input from a human operator at the retail establishment.

Table 1000 includes a column 1002 for listing the retailer identifiers of the corresponding retail establishments, and a column 1004 for listing the offer identifiers for the corresponding offers to be outputted on behalf of the retail establishments. Column 1006 in table 1000 lists the qualifying conditions for the respective offers. For example, a qualifying condition may prescribe that the corresponding retail establishment be open at the current time and for at least another one-half hour. As another possible qualifying condition, it may be required that the retail establishment have issued a “start” or trigger signal and not have rescinded the signal. Another type of qualifying condition may call for business to be slow, as measured against a threshold number of transactions per hour or per another time period.

In table 1000, column 1008 stores data which indicates the current status of the retail establishment relative to the qualifying condition. Columns 1010 and 1012 respectively store the time at which the status information in column 1008 was last updated, and the schedule, if any, upon which updates are to occur. For example, updates may occur every hour or at other regular intervals.

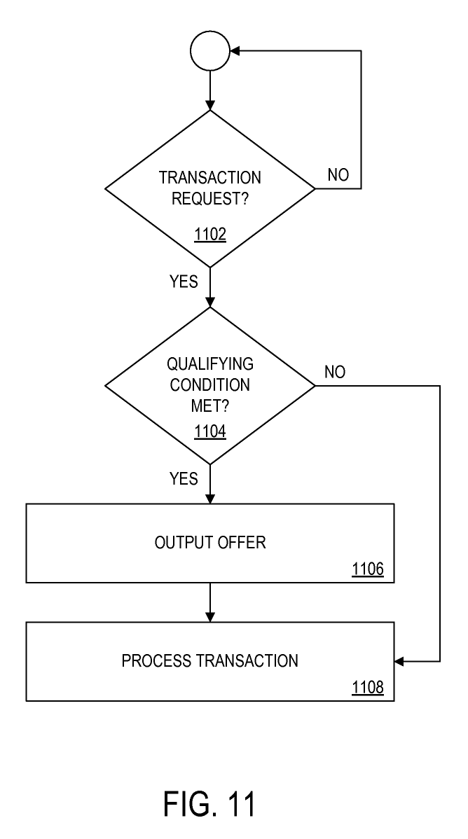

FIG. 11 is a flow chart that illustrates, at a high level, a process carried out by the system of the present invention. Initially shown in FIG. 11 is a decision block 1102, at which it is determined whether a customer has inputted a transaction request into a vending machine of the system. It should be understood that a transaction request may include the customer operating the product request input device 306 (FIG. 3) of the respective vending machine to request that a product be dispensed.

As long as no transaction request is received, the process idles. However, once a transaction request is received, decision block 1104 is implemented. At decision block 1104 it is determined whether a qualifying condition for outputting of an offer from the vending machine has been met. The determination that a qualifying condition has been met may be made, for example, by the controller, based on information provided by a retailer device at a retail establishment associated with the vending machine in question. The information from the retailer device may, in turn, be based upon a signal outputted from a sensor connected to the retailer device. It is to be understood that the determination made by the controller may be made by referring to the qualifying condition database 220 (FIG. 2). A consequence of the determination that a qualifying condition has been met may be that the controller places the corresponding vending machine in an offer mode such that the vending machine responds to transaction requests by outputting offers.

Accordingly, step 1106 follows block 1104 if a positive determination has been made at block 1104. At step 1106 the vending machine outputs an offer. This may be done by printing the offer on a coupon and dispensing the coupon to the customer.

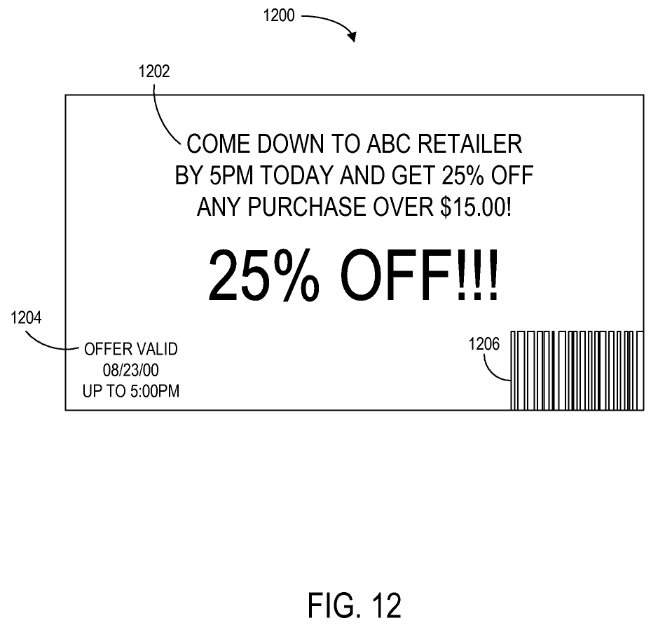

FIG. 12 shows a coupon 1200 which is an example of a type of offer that may be outputted at step 1106. The coupon 1200 includes content 1202 which states to the customer the terms of the offer. Stated at 1204 is a term of the offer which provides that the offer is only valid for a limited period of time on the day that the coupon is issued. The coupon 1200 also has a bar code 1206. The bar code 1206 may be read at the retail establishment when the coupon is redeemed in order to identify the offer. By identifying the offer, the issuing vending machine may be identified to aid in determining compensation that is due to the proprietor of the vending machine. Furthermore, reading the bar code on the coupon makes it possible to determine which offers are successful in inducing the customer to patronize the retail establishment, and which are not.

There are other ways in which the vending machine may output an offer in addition to or as an alternative to printing and dispensing a coupon. For example, the offer may be displayed on a CRT or another type of display. The displayed offer may include a code that the customer can present at the associated retail establishment to obtain the benefit of the offer.

The offer may also be presented in audible form by a speaker that is part of the vending machine. As another alternative, and assuming that the customer has used a cell phone to request the transaction and arrange for payment of the transaction, the offer may be presented to the customer in audible form via the customer's cellular telephone. Data representing the offer could also be transmitted from the vending machine to a PDA or other device carried by the customer.

The last step shown in FIG. 11 is step 1108, at which the vending machine processes the requested transaction. This may include an entirely conventional sequence of steps such as receiving payment, making change, and dispensing the requested product. Although the step of processing the transaction is shown as being after the outputting of the offer, it is also contemplated to perform these two tasks substantially simultaneously or to process the transaction before outputting the offer.

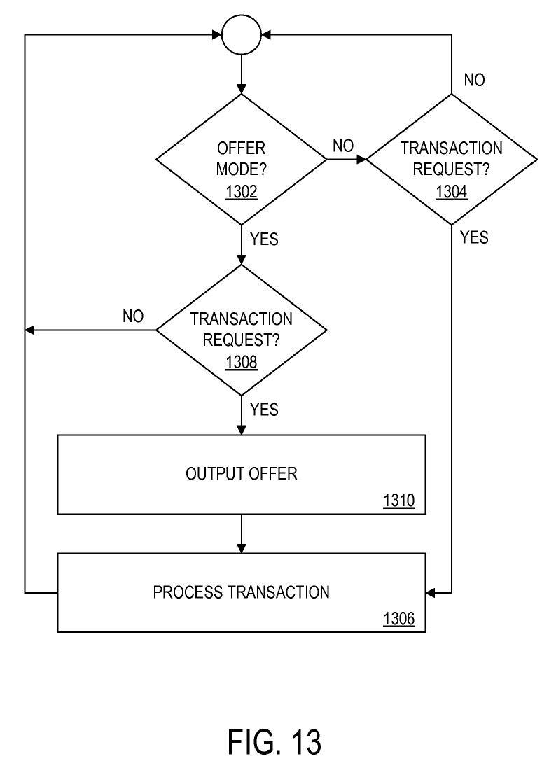

FIG. 13 is a flow chart that illustrates a process carried out at a typical one of the vending machines 102.

Initially in FIG. 13 is a decision block 1302 at which it is determined whether the vending machine is in an offer mode. When the vending machine is in an offer mode, the vending machine is arranged to output offers in accordance with the invention. When the vending machine is not in an offer mode, it does not output offers.

In one embodiment of the invention, the vending machine is placed in an offer mode only in response to a command received from the controller 104. In another embodiment of the invention the vending machine is placed in an offer mode only in response to a command from a retailer device. According to still another embodiment of the invention, a vending machine places itself in an offer mode based on information received from one or more of the controller 104 or a retailer device.

If the vending machine, as determined at block 1302 is not in an offer mode, then the vending machine operates in a conventional manner to receive and fulfill transaction requests, as indicated by block 1304 and process step 1306.

On the other hand, if it is determined at block 1302 that the vending machine has been placed in offer mode, then the vending machine responds to a transaction request (block 1308) by outputting an offer (step 1310) and then processing the requested transaction in a conventional fashion (step 1306).

In one embodiment of the invention, a command from the controller that places the vending machine in an offer mode also downloads to the vending machine data which contains the content of the offer to be outputted by the vending machine.

In another embodiment, the command from the controller includes an indication of an offer that has been previously stored in the vending machine. The previously stored content is then outputted at step 1310 in response to the indication included in the command.

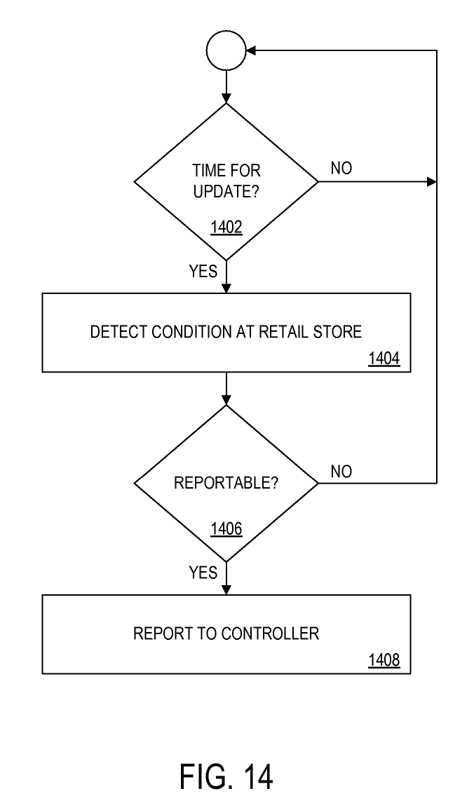

FIG. 14 is a flow chart that illustrates a process carried on at a typical one of the retailer devices 106. Initially, as indicated by block 1402, this process idles until it is time for the retailer device to update the status of a condition at the retail establishment. When it is time for an update, step 1404 follows block 1402. At step 1404 the condition in question at the retail store is detected. The condition to be detected may be, for example, a condition that indicates whether or not the store is busy. One such condition would be how frequently transactions are occurring at a POS terminal or a group of POS terminals in the retail establishment. In this case, if the retailer device is a POS terminal or POS terminal controller, the condition may be detected directly from transactions occurring at the POS terminal or group of POS terminals. Other conditions that may indicate the degree of traffic in the store would be the presence of a relatively large number of people in a service queue or a rate at which people are entering and/or leaving the store. Conditions of this type may be detected via a sensor or sensors interfaced to the retailer device. For example, conventional motion detectors or infrared sensors may be used. Beam sensors may also be used. The sensors may be deployed adjacent to an area at which the service queue is formed, and/or adjacent a door to the retail establishment.

Once information indicative of the status of the condition has been obtained, it is next determined, at block 1406, whether the status is such that it should be reported to the controller. For example, the status may be compared with the status most recently reported to the controller, and only a change or a significant change in the status would be reported. In one embodiment, a condition such as number of transactions in the last five minutes is compared with a threshold quantity, and if the comparison with the threshold is the same as in the last report, no report is made.

If a reportable change in status has been determined to have occurred at block 1406, then step 1408 follows. At step 1408 the change in status is reported to the controller.

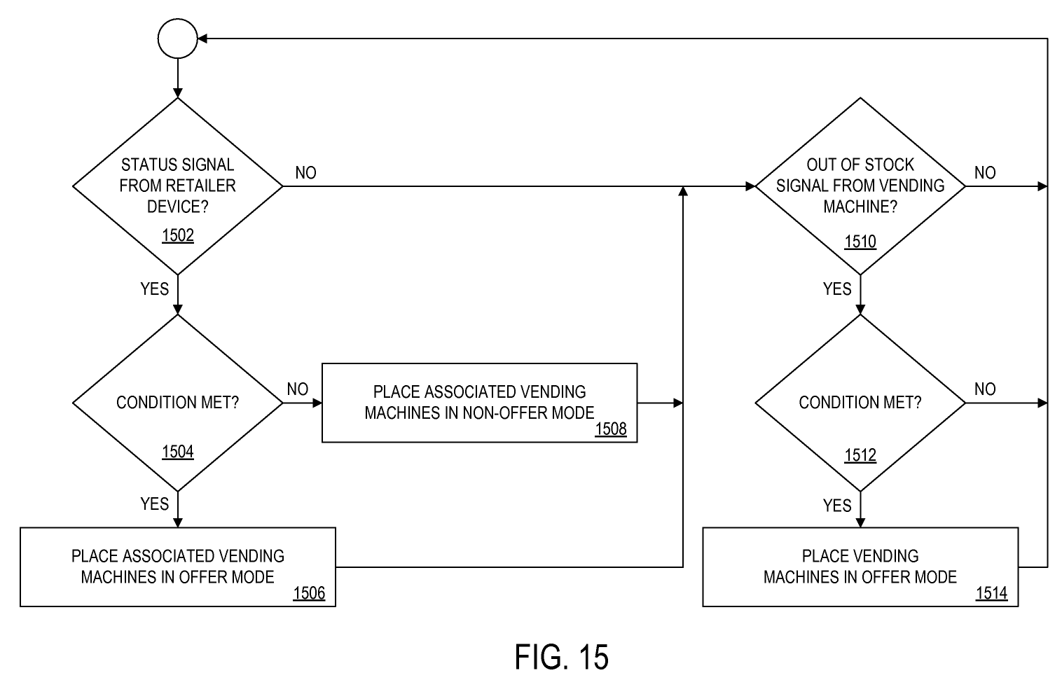

FIG. 15 is a flow chart that illustrates a process carried on at the controller. Initially in the process of FIG. 15 is block 1502, at which it is determined whether the controller has received from a retailer device a signal indicating a change in status at a retail establishment. If a signal that indicates a change in status is received, then block 1504 follows block 1502. At block 1504 it is determined whether the change in status is such that a qualifying condition for an offer has been met. This may be done by reference to the qualifying condition database 220 (FIG. 2), which is illustrated in FIG. 10. For example, the signal from the retailer device may indicate that a relatively large number of people are present in the service queue. The existence of this status may indicate that the condition for an offer is not met. On the other hand, if the signal from the retailer device indicates that few or no people are present in the service queue, then the condition may be met. As another example, if the status signal from the retailer device indicates that the number of transactions per unit time is less than a threshold figure, then it may be determined at block 1504 that a condition for outputting an offer from an associated vending machine or vending machines is met.

If at block 1504 it is determined that a qualifying condition for an offer is met, then step 1506 follows block 1504. At step 1506 the controller sends a command to the appropriate vending machine or machines to place such vending machines in an offer mode. As noted before, the command signal may include data indicative of the text of the offer.

If at block 1504 it is found that the qualifying condition is not met, then step 1508 follows block 1504. At step 1508 the controller sends a command to the corresponding vending machine or machines such that the vending machines are no longer in an offer mode.

Decision block 1510 follows step 1506 or step 1508 as the case may be. Alternatively, block 1510 follows block 1502 if a negative determination is made at block 1502. At block 1510 it is determined whether a signal is received from a vending machine to indicate that the vending machine is out of stock of one or more of the products to be dispensed by the vending machine. If not, the process of FIG. 15 loops back to block 1502.

However, if a positive determination is made at block 1510, then block 1512 follows. At block 1512 it is determined whether a qualifying condition is met at an associated retail establishment such that an offer should be outputted by the vending machine at times when customers request purchase of the out of stock item. This determination may be made, for example, by reference to the qualifying condition database 220 (FIG. 2). Alternatively, the determination may be made by querying a retailer device at the associated retail establishment.

If it is determined at block 1512 that the qualifying condition is not met, then the process of FIG. 15 loops back to block 1502. Otherwise, i.e. if it is found that the qualifying condition is met, then step 1514 follows block 1512. At step 1514 the controller transmits a command to the vending machine which sent the out of stock signal to place the vending machine in an offer mode. In this offer mode, the vending machine outputs an offer whenever a customer requests the out of stock item.

It has previously been suggested that a vending machine may be associated with more than one retail establishment and that more than one potential offer may be associated with a given vending machine. Consequently, the processes described above may include logic for selecting one offer from among a number of different offers for which qualifying conditions are met. For example, there may be two retail stores associated with a given vending machine, of which one store has agreed to a higher payment than the other in respect of offers outputted by the vending machine. Accordingly, at times when business is slow at both stores, the controller may command the vending machine to output the offer that corresponds to the higher paying store.

There may also be plural offers that are applicable to a given store and arranged to be outputted by a single vending machine at different times. The retailer device at the store or the controller or a vending machine may be configured to select which among the offers is to be outputted by the vending machine.

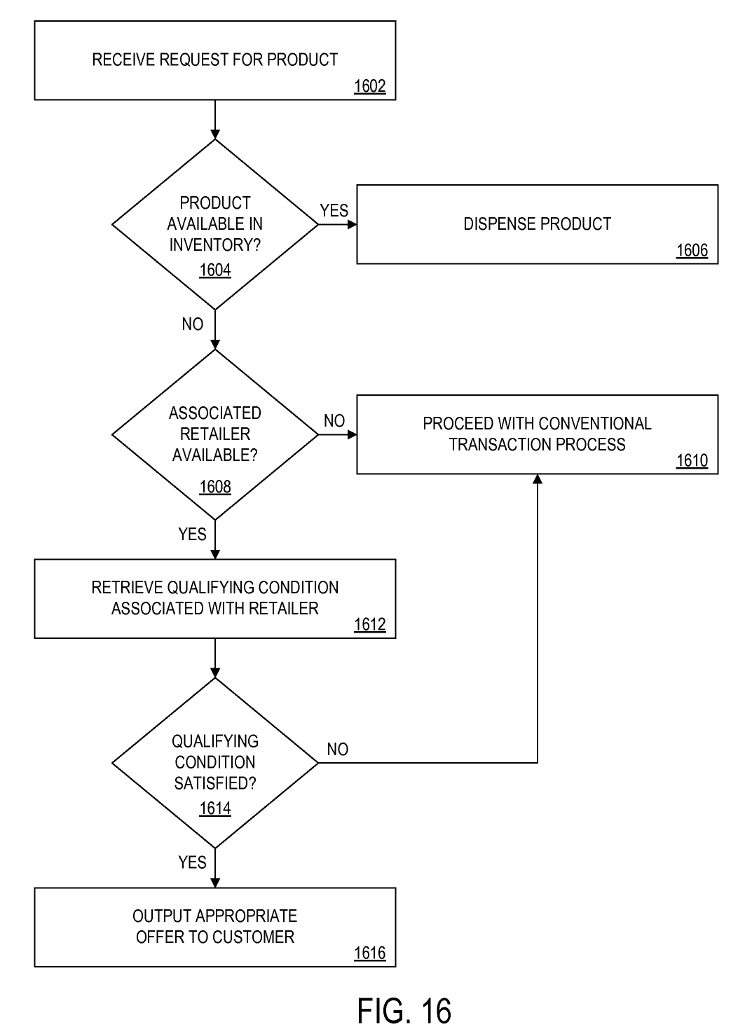

FIG. 16 is a flow chart that illustrates how a vending machine copes with an out-of-stock situation according to the invention.

Initially, at step 1602, a request for a product is received. It is then determined, at block 1604, whether the requested product is available in inventory. If so, the product is dispensed in a conventional manner (step 1606).

If at block 1604 a negative determination is made, the block 1608 follows block 1604. At block 1608 it is determined whether a retailer has been associated with the vending machine. If not, a conventional practice for dealing with an out-of-stock situation is invoked (step 1610). But if a positive determination is made at block 1608, then step 1612 follows block 1608. At step 1612, a qualifying condition associated with the retailer is retrieved, and a determination is made as to whether the qualifying condition is satisfied (block 1614). If the qualifying condition is not satisfied, step 1610 is invoked. If the qualifying condition is satisfied, then an appropriate offer is outputted to the customer (step 1616).

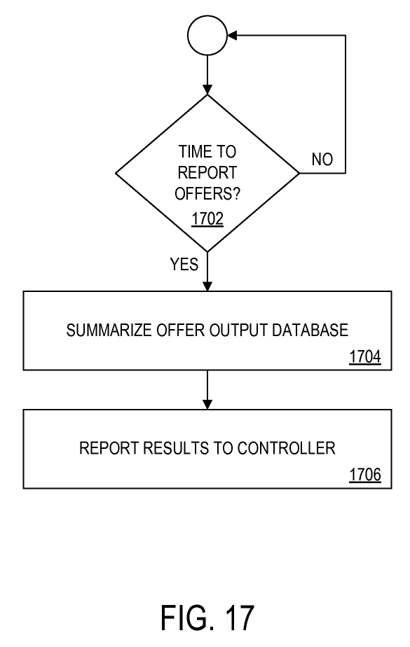

FIG. 17 is a flow chart that illustrates a process carried out in a typical vending machine of the system relating to record keeping for the purpose of calculating payments due in connection with the system.

As indicated by block 1702, the process of FIG. 17 idles until it is time for the vending machine to report to the controller with respect to offer output activity that has been carried out by the vending machine. At an appropriate time, step 1704 follows step 1702. At step 1704, the vending machine generates data that summarizes activities that have been carried out by the vending machine in connection with outputting offers. The data needed to prepare the summary may be obtained, for example, from the offer output database 324 (FIG. 3) which was illustrated in FIG. 9. Then, at step 1706, the vending machine transmits to the controller the data that indicate the offer output activities that have been performed by the vending machine.

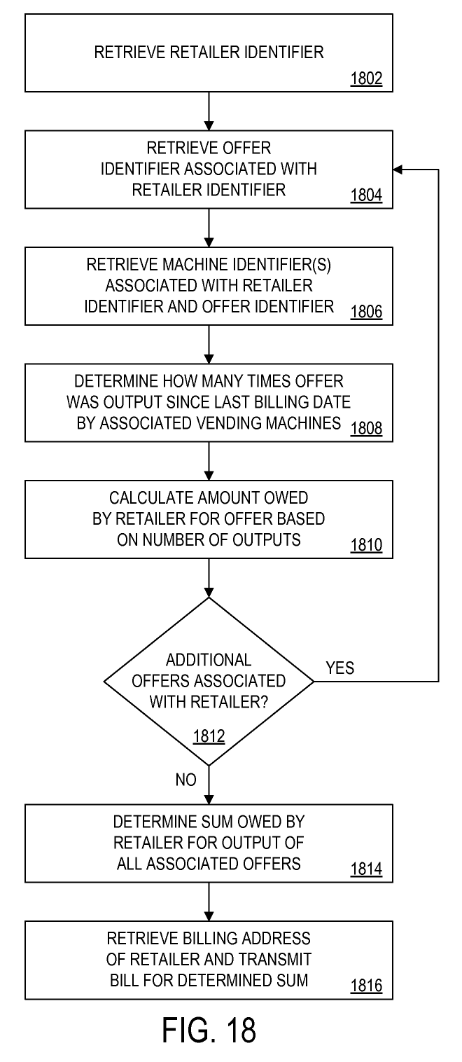

FIG. 18 is a flow chart that illustrates a billing and reconciliation process performed by the controller to determine, for example, what payments are owed by a retailer. This process is performed in connection with an embodiment wherein the retailer pays a fee to the system (proprietor of the controller) based on the number of times offers are output on behalf of the retailer. A process like that discussed below may also be performed to determine what amount or amounts are owed to proprietors of the vending machines for providing the service of outputting offers.

Initially in FIG. 18 is a step 1802, at which the controller (or, more precisely, the processor thereof) retrieves a retailer identifier that corresponds to a retail establishment for which billing information is to be gathered. Then, at step 1804, the controller retrieves an offer identifier that corresponds to an offer that is programmed to be output on behalf of the retail establishment. This information may be obtained, for example, by reference to the offer database 218 (illustrated in FIG. 7).

Next, at step 1806 the vending machine identifiers associated with the retailer identifier and the offer identifier are retrieved. This may be done by reference to the associations database 216, which was illustrated in FIG. 6. Then, at step 1808, the controller may use the offer output summary data that was uploaded by the vending machines pursuant to the process of FIG. 17 to determine how many times the offer in question was outputted by the associated vending machines since the last billing date. Next, at step 1810, the controller calculates, based on the information gathered from the vending machines, an amount owed by the retail establishment on account of offers outputted by the vending machines. In connection with this step the associations database 216 is referenced for payment terms data that indicates what payment arrangements have been made.

It is then determined, at block 1812, whether there are additional offers that are associated with the retailer. This may be done, as in the case of step 1804, by reference to the offer database 218. If a positive determination is made at block 1812, then the process loops back to step 1804. Otherwise, the process advances to step 1814. At step 1814 it is determined how much the retailer is due to pay in respect of the number of occasions on which all of the associated offers have been outputted by vending machines. Then, at step 1816, the billing address of the retailer is retrieved and a bill in an appropriate amount is generated and transmitted to the retailer.

The following examples illustrate how various embodiments of the invention operate from the point of view of the customer.

### EXAMPLE 1

A customer goes to a soda vending machine and purchases a can of soda. As the can is being dispensed, a coupon is also dispensed and a message is scrolled across a display screen that is installed on the vending machine. The coupon and the message have the same text: “Use this coupon at the ABC retailer across the street within the next hour and get 20% off any purchase”. This offer may have been outputted because the retailer's sales for the day have been at a low level and there are currently few or no customers at the store. Consequently, the retailer made use of the inventive system and its association with the vending machine to output an offer that may tend to lead the customer to patronize the store. The offer included in the coupon and the message displayed on the vending machine may be an announcement of a promotion that is already in effect for other customers at the retail store.

### EXAMPLE 2

A customer drives into a gas station and fills up the tank of her car with gasoline. The gas station has a convenience store and a vending machine standing outside the convenience store. The customer goes to the vending machine and presses the button to request the customer's favorite type of soda. The vending machine is out of stock of the requested type of soda, but the vending machine has been placed in an offer mode because of the combination of conditions that (i) it is out of stock and (ii) the convenience store is not very busy. Accordingly, the vending machine outputs a coupon and a message to the customer stating “We apologize for the inconvenience. Please use this coupon inside the store to purchase your soda and get a complimentary bag of chips.” The customer does not consider herself to be unduly inconvenienced because there is no waiting at the convenience store and she gets a free bag of chips. In addition, the customer may make additional purchases while in the store, which is advantageous for the proprietor of the store.

### EXAMPLE 3

A customer visits a vending machine to purchase a snack. While he is doing so a message is outputted to him via a screen on the vending machine, as follows: “Visit the ABC Discount Store at 123 Main Street on your way home tonight and use this code (XYZ123) to receive 50% off any bunch of flowers. Show your loved one that you care!” An offer of this type may allow the retailer to address an overstock condition in a particular type of product or may simply be effective in bringing more traffic to the store.

As is suggested by the previous example, in addition to offers for which the content is pre-stored in a database, the system may also be adapted so that retailers are permitted to use a retailer device to compose the text of an offer that is to be transmitted to associated vending machines for outputting by the vending machines.

The system of the present invention makes it possible to use a network of vending machines to selectively direct customer traffic to associated retailers. This may be done in response to conditions at the retailer, such as a lack of traffic, or in response to conditions at the vending machines, such as out of stock conditions. In effect vending machines are transformed into promotional kiosks that serve nearby retail stores as part of a system that can respond in real time to changing conditions in the retail stores.

When a vending machine is in an out-of-stock condition it may operate to direct the customer to another vending machine that the system knows is nearby and is not out of stock of the requested item. This may be done by outputting a suitable message to the customer.

In a case where the customer has deposited money in a vending machine and been informed that it is out of stock, the customer may be offered the option of receiving his or her money back, or receiving a coupon or other offer that is redeemable at a nearby retail establishment or at another vending machine. If the offer is redeemable at another vending machine, the offer may include a redemption code to be inputted into the other vending machine. If the offer is redeemable at a retail establishment, the proprietor of the vending machine may have agreed to compensate the proprietor of the retail establishment for fulfilling the offer.

In embodiments of the invention discussed above, offers are provided to customers who request transactions at vending machines. It is also contemplated that vending machines may output offers to customers detected nearby the vending machines even before a transaction is requested. The customer may be detected by a sensor device installed in the vending machine, or by determining the location of a cellular telephone carried by the customer.

In cases where the identity of the customer is known, as where the customer is using a cellular phone, a smart card or a credit card to pay for the vending machine transaction, attributes of the customer may be used to determine whether to output an offer, or to select an offer to be outputted. The customer attributes to be considered may include product preferences or lack of preferences, demographic information, or purchasing history at either retailers or vending machines.

In addition to using vending machines to direct customer traffic to brick-and-mortar retailers, it is also contemplated to use vending machines to output offers to patronize online retail sites.

There have been described above situations in which a vending machine outputs an offer because it is out of stock. It is further contemplated that the vending machine may output an offer when the vending machine inventory is low but not out of stock. This may particularly be done when the vending machine knows that it is not scheduled to be restocked for a considerable period of time. The vending machine may also output an offer because it is out of change or low on change.

Other factors that may be taken into account in determining whether to output an offer may be external conditions such as traffic or weather, or a number of times that customers have recently been directed to a retailer.

It has been noted above that payment to a vending machine may be made via a cellular telephone. In this case, the vending machine may output an offer to the customer through the cellular telephone. The offer may be redeemable at a retail store by the customer mentioning his or her cellular telephone number, which functions as a redemption code.

The methods described herein as sequences of steps are not limited to being performed in the order set forth herein, but may be performed in any order that is practical.

Although the present invention has been described with respect to preferred embodiments thereof, those skilled in the art will note that various substitutions, modifications and variations may be made with respect to the embodiments described herein without departing from the spirit and scope of the present invention.

What is claimed is:

1. A method of operating a vending machine, comprising:
receiving, from a customer, a request to dispense an item at the vending machine;
determining, by the vending machine, that the item will not be dispensed by the vending machine;
determining, by the vending machine, a state of a service queue at a retail establishment; and
outputting to the customer, in the case that the state of the service queue is determined to indicate fewer than a predefined threshold number of customers waiting in the service queue, a coupon for the item to be redeemed at the retail establishment, wherein the outputting is conducted based on the determination that the item will not be dispensed.

2. The method of claim 1, wherein the determining that the item will not be dispensed by the vending machine comprises:
determining that the item cannot be dispensed by the vending machine due to the item being out of stock at the vending machine.

3. The method of claim 1, wherein the determining that the item will not be dispensed by the vending machine comprises:
determining that an amount of inventory of the item at the vending machine is below a predefined inventory threshold.

4. The method of claim 1, wherein the coupon is for a discount on the item if redeemed by the customer at the retail establishment.

5. A method, comprising:
determining, by a device associated with a retail establishment, a state of a service queue at the retail establishment;
transmitting, in the case that it is determined that the state of the service queue is indicative of fewer than a predefined threshold number of customers waiting in the service queue, a signal to a vending machine from the retail establishment, the signal being operative to cause the vending machine to output, to a customer at the vending machine, a coupon that is redeemable at the retail establishment; and
accepting, at the retail establishment and from the customer, the coupon for redemption.

6. The method of claim 5, wherein the signal is only operative to cause the vending machine to output the coupon in the case that one or more of: (i) the vending machine is low on change; (ii) the vending machine is out of change; and (iii) the vending machine has lower than a predetermined threshold of an item requested by the customer in stock.

7. The method of claim 5, wherein the vending machine comprises an ATM machine.

8. The method of claim 5, wherein the vending machine comprises a parking meter device.

9. The method of claim 5, wherein the vending machine comprises a slot machine.

10. The method of claim 5, wherein the vending machine comprises a laundry machine.

11. A system, comprising:
a detection device located at a retail establishment, the detection device being operable to-detect a current rate of transactions being experienced at the retail establishment;
a processing device associated with the retail establishment, the processing device being operable to determine that the current rate of transactions is indicative of fewer than a predefined threshold rate of transactions; and
a transmitting device associated with the retail establishment, the transmitting device being operable to transmit, to a vending machine and in the case that the current rate of transactions is determined to be indicative of fewer than the predefined threshold rate of transactions, a trigger signal; and
the vending machine including:
a receiving device operable to receive the trigger signal;
a controller operable to determine, based on a receipt of the trigger signal, that a coupon is to be output to a customer of the vending machine; and
an offer device operable to selectively output the coupon in response to the controller; and
the retail establishment including:
a redemption device operable to accept the coupon for redemption at the retail establishment.

12. The system of claim 11, wherein the controller is further operable to determine that the coupon is to be output based on one or more of: (i) an indication that the vending machine is low on change; (ii) an indication that the vending machine is out of change; and (iii) an indication that the vending machine has lower than a predetermined threshold amount of inventory of an item requested by the customer in stock.

13. The system of claim 11, wherein said vending machine comprises an electronic toll booth.

14. The system of claim 11, wherein said vending machine comprises an arcade game device.

15. A method, comprising:
determining, by a vending machine, an indication of a transaction request of a customer;
determining, by the vending machine, that an item associated with the customer's transaction request will not be dispensed;
determining, by the vending machine, that a rate of transactions currently being experienced by a retail establishment is less than a predetermined threshold rate of transactions; and
outputting, by the vending machine, based at least in part on (i) the determination that the rate of transactions currently being experienced by the retail establishment is less than the predetermined threshold rate of transactions and (ii) the determination that the item will not be dispensed, an offer to the customer.

16. The method of claim 15, wherein the offer comprises a discount for the item if purchased by the customer at the retail establishment.

17. The method of claim 15, wherein the offer comprises a discount for the item if purchased by the customer at the retail establishment within a limited period of time following the customer's transaction request at the vending machine.

18. The method of claim 15, wherein the outputting of the offer is further based on one or more of: (i) a determination that the vending machine is low on change; (ii) a determination that the vending machine is out of change; and (iii) a determination that the vending machine has lower than a predetermined threshold amount of inventory of the item in stock.

19. The method of claim 15, wherein the determining that the item will not be dispensed comprises:
determining that the item is out of stock at the vending machine.

20. The method of claim 15, wherein the determining that the item will not be dispensed comprises:
determining that the an inventory of the item at the vending machine is lower than a predetermined inventory threshold.

21. The method of claim 15, wherein the outputting comprises transmitting an indication of the offer to a device associated with the customer.

22. The method of claim 21, wherein the customer device comprises a mobile terminal.

23. The method of claim 22, wherein the mobile terminal comprises one or more of a cellular telephone and a Personal Digital Assistant (PDA).
